(19) United States
(12) Patent Application Publication
(10) Pub. No.: US 2014/0318122 A1
(43) Pub. Date: Oct. 30, 2014

(54) Blow Off Valve and Related System and Method

(71) Applicants: Daniel J. Begley, Franklin, NJ (US); Brydon Foster, Vancouver, WA (US); Richard Harris, Camas, WA (US)

(72) Inventors: Daniel J. Begley, Franklin, NJ (US); Brydon Foster, Vancouver, WA (US); Richard Harris, Camas, WA (US)

(21) Appl. No.: 13/873,094

(22) Filed: Apr. 29, 2013

(51) Int. Cl. F02B 37/12

(52) U.S. Cl. CPC F02B 37/12
USPC 60/602; 29/890.12

(57) ABSTRACT

The present invention is directed to a blowoff valve assembly that utilizes a non-coiled spring for biasing a valve member in a compact space. The invention is further directed to a turbocharger system utilizing a blowoff valve with a non-coiled spring.

### CROSS-REFERENCE TO RELATED APPLICATION

Not applicable.

### FIELD OF THE INVENTION

The present invention relates to the field of combustion engine components, and, more particularly, to a blowoff valve for a combustion engine turbocharger or supercharger.

### BACKGROUND OF THE INVENTION

A blowoff valve, or dump valve, is a pressure release system present in most turbocharged engines that functions to prevent compressor surge and reduce wear on the turbocharger system and engine. Blowoff valves relieve the damaging effects of compressor “surge loading” by allowing the compressed air to vent to the atmosphere (making a distinct hissing sound) or to recirculate into the intake upstream of the compressor inlet.

With today's increasingly powerful engines and performance turbocharging systems, the demands on a blowoff valve increase. As such, present day blowoff valves must effectively vent larger volumes of air with increasingly demanding response times, requiring larger port and spring sizes, which further require larger BOV bodies to accommodate.

### SUMMARY OF THE INVENTION

In view of the foregoing background, it is therefore an object of the present invention to provide a compact blowoff valve with increased performance for a turbo-charged engine. As such, the present invention is directed to a blowoff valve assembly that utilizes a non-coiled spring for biasing a valve member in a compact space.

The blowoff valve includes a valve body defining an air inlet and an air outlet with an internal passage extending therebetween. A valve member is arranged in the internal passage and movable into an airflow restricting position, by which airflow between the air inlet and the air outlet is restricted. The valve member is biased into the airflow restricting position via a non-coiled spring such that air pressure at the air inlet above a blowoff threshold moves the valve member out of the restricting position, permitting airflow between the air inlet and the air outlet. A particularly useful non-coiled spring for the blowoff valve assembly includes a wave spring (or flat wire compression spring) such as, for example, Smalley Wave Springs as described at www.smalley.com/wave springs/about springs.asp.

In some embodiments, the valve body of the blowoff valve includes an access port and a valve cover removably attached to the valve body in covering alignment with the access port.

The present invention is further directed to a turbocharger system for a combustion engine that utilizes a blowoff valve including a non-coiled spring, as described herein.

These and other objects, aspects, and advantages of the present invention will be better appreciated in view of the drawings and the following detailed description of the embodiments.

### BRIEF DESCRIPTION OF THE DRAWINGS

For a fuller understanding of the nature of the present invention, reference should be had to the following detailed description taken in connection with the accompanying drawings in which:

FIG. 1 is an exploded view of a blowoff valve assembly as positioned on a turbocharger, according to an embodiment of the present invention;

FIG. 2 is top perspective view of the blowoff valve assembly of FIGS. 1, according to an embodiment of the present invention;

FIG. 3 is bottom perspective view of the blowoff valve assembly of FIG. 1, according to an embodiment of the present invention;

FIG. 4 is a perspective view of an exemplary non-coiled spring utilized in an embodiment of the present invention;

FIGS. 5A and 5B are cross sectional views of embodiments of valve members of the present invention with differences in sizes of the smaller bores relative to the overall sizes of the valve members illustrated;

FIG. 6 is a cross-sectional view of an embodiment of a blowoff valve of the present invention; and

FIG. 7 is a top perspective view of the embodiment of FIG. 6.

Like reference numerals refer to like parts throughout the several views of the drawings.

### DETAILED DESCRIPTION

In the Summary of the Invention, the Detailed

Description and the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

The terminology used herein is for the purpose of describing particular embodiments only and is not intended to be limiting of the invention. As used herein, the indefinite articles “a”, “an” and “the” should be understood to include plural reference unless the context clearly indicates otherwise.

The phrase “and/or,” as used herein, should be understood to mean “either or both” of the elements so conjoined, i.e., elements that are conjunctively present in some cases and disjunctively present in other cases.

As used herein, “or” should be understood to have the same meaning as “and/or” as defined above. For example, when separating a listing of items, “and/or” or “or” shall be interpreted as being inclusive, i.e., the inclusion of at least one, but also including more than one, of a number of items, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

The term “comprises” is used herein to mean that other elements, steps, etc. are optionally present. When reference is made herein to a method comprising two or more defined steps, the steps can be carried out in any order, or simultaneously (except where the context excludes that possibility), and the method can include one or more steps which are carried out before any of the defined steps, between two of the defined steps, or after all of the defined steps (except where the context excludes that possibility).

As used herein, the terms “including”, “includes”, “having”, “has”, “with”, or variants thereof, are intended to be inclusive similar to the term “comprising.”

In this section, the present invention will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art.

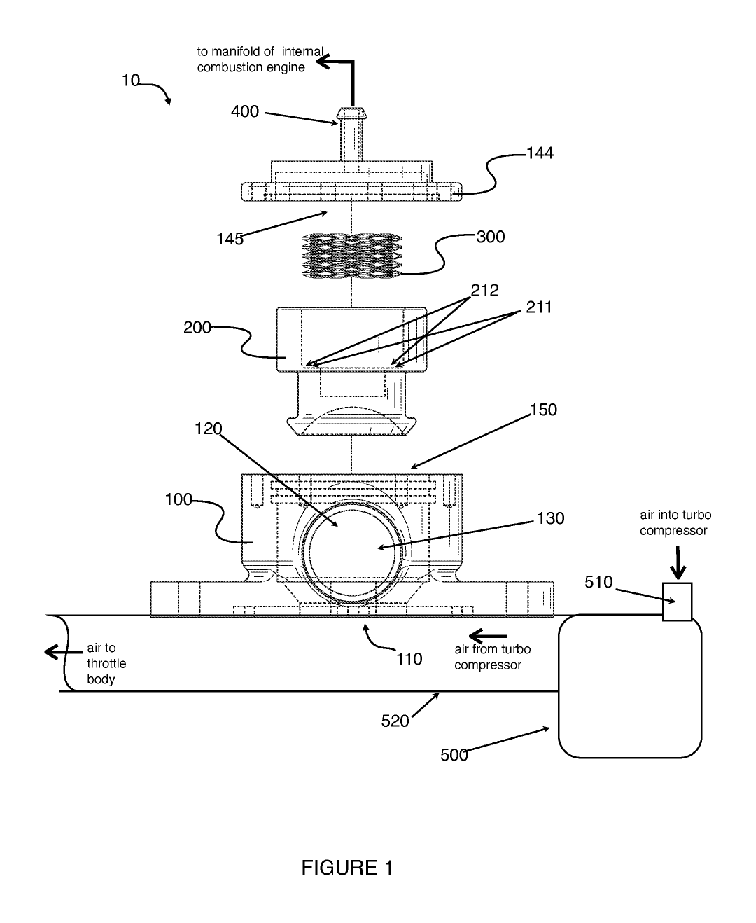

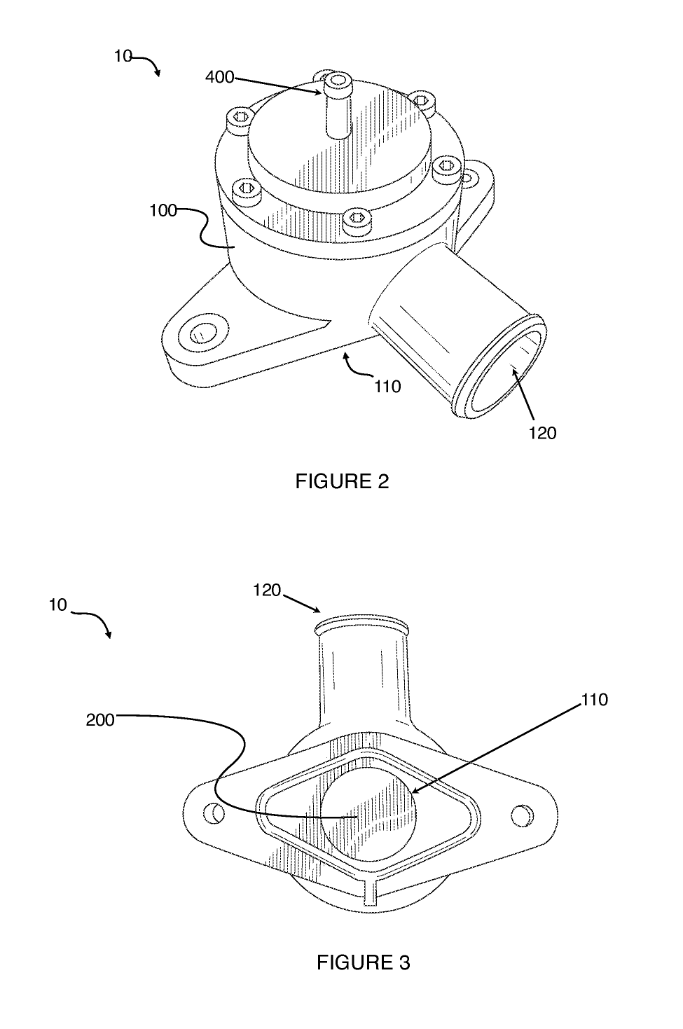

As illustrated in the accompanying drawings, and with primary reference to the exploded view in FIG. 1 and the top, perspective view in FIG. 2, the present invention is directed to a blowoff valve, generally indicated as 10, for use on a turbocharged or supercharged engine. The blowoff valve 10 includes a valve body 100 defining an air inlet 110 (as illustrated in the bottom view of the blowoff valve in FIG. 3) and an air outlet 120 with an internal passage 130 extending therebetween. The air inlet 110 functions as the input to the blowoff valve 10 from the pressurized side of the turbocharger. The air outlet 120 functions to release air from the blowoff valve 10 into the atomosphere or couples with another hose/tubing to recirculate some, or all, of the air that is released from the valve back to the turbocharger inlet. The blowoff valve 10 further includes a valve member 200 arranged in the internal passage 130 and movable into an airflow restricting position in which airflow between the air inlet 110 and the air outlet 120 is restricted.

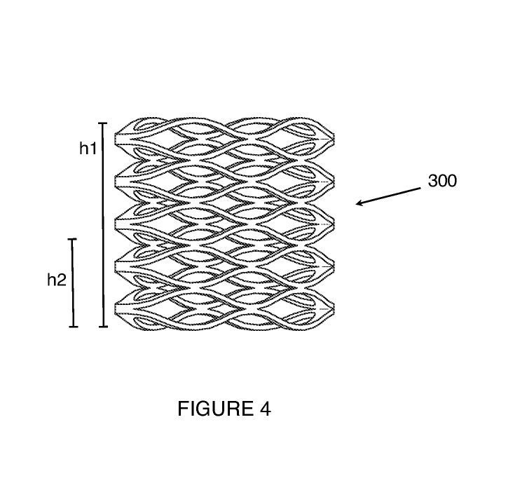

Another feature of the blowoff valve 10 includes a non-coiled spring 300 biasing the valve member 200 into the airflow restricting position. As such, air pressure at the air inlet 110 above a blowoff threshold will move the valve member 200 out of the restricting position, permitting airflow between the air inlet 110 and the air outlet 120. The non-coiled spring is generally selected from wave springs (as illustrated in FIG. 4), leaf springs, and torsion springs. The use of a non-coiled spring is advantageous in the blowoff valve 10 since it provides the same force and deflection as ordinary coiled compression springs at up to about 50% of the coiled spring's height. FIG. 4 illustrates the uncompressed height of the wave spring (designated as h1) versus the compressed state (h2).

Typically, the non-coiled spring 300 is about 10 millimeters (mm) to about 100 mm in length when in a non-compressed state. In particularly preferred embodiments, the length of the non-coiled spring 300 is about 20 mm to about 40 mm when in a non-compressed state. As a result of the small footprint of the non-coiled spring 300, the valve body 100 can be generally smaller than traditional blowoff valve bodies and provide rapid response time. By reducing the size requirements for the valve body 100, the size of the valve member 200 is reduced. This allows for less mass, such that with the same amount of force applied to open and close the valve member 200, higher speeds can be achieved, as shown in the equation F=m×a (Force equals mass times acceleration).

As further illustrated in FIG. 1, the blowoff valve may also include a pressure control connector 400 for regulating vacuum pressure within the valve body 100. The pressure control connector 400 extends from the valve body 100 and is removably attached to a hose or tubing that interconnects with the intake manifold. In some embodiments, the valve body 100 includes an access port 150 with a valve cover 144 removably attached to the valve body 100 in covering alignment with the access port 150. This embodiment allows for removal of the valve cover 144 to clean and/or repair the internal components of the blowoff valve 10. Additionally, the pressure control connector 400 may extend from the valve cover 144.

The pressure control connector 400 functions to provide interconnection of the blowoff valve 10 with the intake manifold of the engine such that when the pressure in the intake manifold is positive (in boost), the resulting pressure causes the valve member 200 to remain in the restricting position. Conversely, when the throttle plate of the combustion engine closes (i.e., the driver lets off the gas), the air in the intake manifold is drawn into the engine causing zero or negative pressure in the intake manifold. This then allows the valve member 200 to move out of the airflow restricting position.

In additional embodiments, the valve member 200 is configured to at least partially surround the non-coiled spring 300 therein. This design provides additional space saving features and further allows the valve body 100 to be manufactured in a smaller form-factor over traditional blowoff valves. The surrounding characteristics of the valve member 200 additionally acts to maintain proper seating of the spring 300 therein.

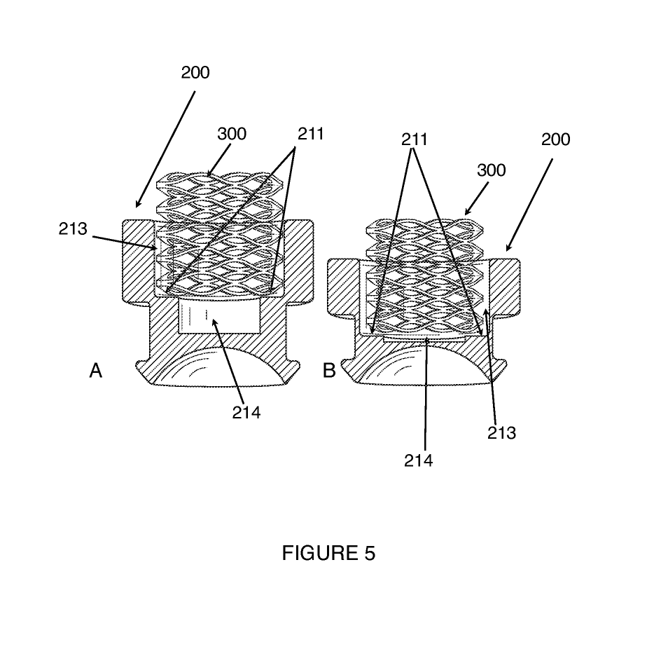

The valve member 200 additionally includes a spring seat 211 for providing a first surface 212 for the non-coiled spring 300 to contact and bias the valve member 200. As further illustrated in the embodiments of FIGS. 5A and 5B, the larger bore 213 of the valve member 200 houses the spring 300. The smaller bore 214 reduces weight and is sized to further reduce the overall size of the valve member 200 based on the desired size of the valve body 100, as can be seen when comparing the valve member 200 in each of the embodiments in FIG. 5A and 5B. Reducing weight and material makes the valve lighter and, thus, faster since the non-coiled spring 300 receives less resistance from the weight of the valve member 200. Such a design also saves on material cost in the valve body 100 and valve member 200, which is very important in mass production. Furthermore, the smaller bore 214 of the valve member 200 is optionally utilized for housing a smaller spring if finer control of seat pressure is desired. Referring again to FIG. 1, the other end of the non-coiled spring 300 would then contact a valve cover 144 that is horizontally positioned and opposite the spring seat 211 for providing a corresponding second surface 145 for the non-coiled spring to contact and bias the valve member 200. In this configuration, the distance between the first surface 212 and the second surface 145 is in a range of about 10 mm to about 50 mm, or preferably in a range of about 12 mm to about 20 mm when the valve member 200 is in the airflow restricting position.

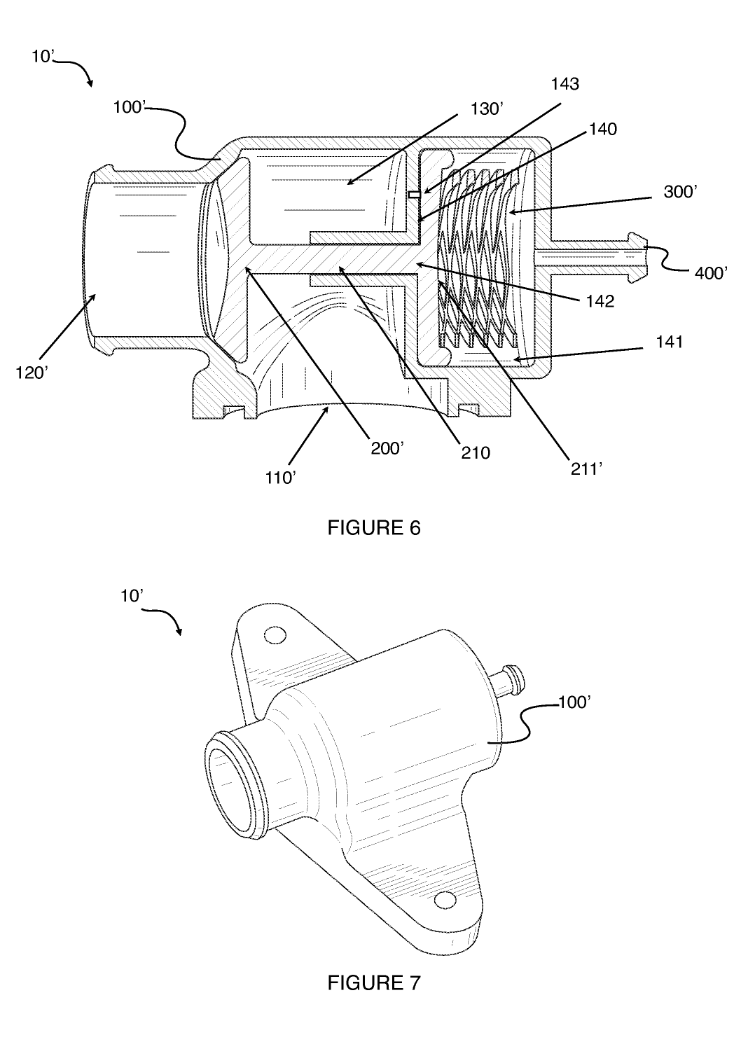

Now turning to FIG. 6 and FIG. 7 and an additional embodiment of a blowoff valve 10′, the valve body 100′ includes an internal wall 140 defining a spring chamber 141 separate from the internal passage 130′ with a non-coiled spring 300′ being arranged therein. Typically, the spring chamber 141 has an internal length from the internal wall 140 to an opposing wall within the chamber 141 of about 10 mm to about 50 mm, or more preferably, about 12 mm to about 20 mm. Optionally, the opposing wall is removably attached to the valve body 100′ to allow for removal and repair/cleaning of the interior and/or for replacing the spring for different applications or to customize a particular application.

Still referring to FIGS. 6 and 7, the internal wall 140 defines a stem passage 142 therethrough, and the valve member 200′ includes a valve stem 210 having a spring seat 211′, the spring seat 211′ being located in the spring chamber 141 and the valve stem 210 passing through the stem passage 142 into the internal passage 130′. The internal wall 140 further defines at least one port hole 143 for providing equalization of pressure in the internal passage 130′ and the spring chamber 141. Likewise, there is a pressure control connector 400′ for regulating vacuum and pressure within the spring chamber 141 relative to the intake manifold, as previously described. This embodiment of the blowoff valve 10′ also includes an air inlet 110′ and an air outlet 120′. In this particular embodiment, the air pressure from the engine turbocharger will force the valve member 200′ closed, instead of providing pressure to open the valve as in the embodiment illustrated in FIG. 1.

It is also contemplated by the present invention that the blowoff valves 10, 10′ are utilized as part of a turbocharger system for an internal combustion engine. As such, the system includes a turbocharger compressor 500 (as illustrated in FIG. 1), the compressor 500 comprising an air input 510 for receiving air into the compressor 500 and an air output 520 for expelling compressed air from the compressor 500. The system further includes a blowoff valve 10, 10′, as described herein, configured such that the air inlet 110 is in communication with the air output 520 of the compressor 500 such that air pressure at the air inlet 110 above a blowoff threshold will move the valve member 200 out of the restricting position permitting airflow between the air inlet 110 and the air outlet 120 of the blowoff valve. The air output 520 of the compressor 500 further connects to the throttle body upstream of the manifold of the internal combustion engine. The blowoff valve 10, 10′ of such a system can further include a pressure control connector 400 interconnected with the intake manifold of the engine via a vacuum hose for regulating the vacuum pressure between the manifold and the valve body 100, 100′.

In another embodiment, the present invention is directed to a method of assembling a compact blowoff valve. The method includes providing a valve body defining an air inlet, an access port, and an air outlet with an internal passage extending therebetween. The method also includes arranging a valve member comprising a spring seat in the internal passage such that it is movable into an airflow restricting position in which airflow between the air inlet and the air outlet is restricted thereby and then positioning a non-coiled spring within the internal passage such that a first end of the non-coiled spring abuts the spring seat and is capable of biasing the valve member into the airflow restricting position. The method further includes attaching a valve cover to the valve body in covering alignment with the access port and opposite the spring seat such that it contacts a second end of the non-coiled spring so that the air pressure at the air inlet above a blowoff threshold will move the valve member out of the restricting position permitting airflow between the air inlet and the air outlet during operation of the assembled blowoff valve. The length of the internal passage of the valve body of the assembled blowoff valve is from about 12 mm to about 20 mm measured from the spring seat of the valve member to the valve cover when the non-coiled spring is biasing the valve member into the airflow restricting position, and the uncompressed length of the non-coiled spring biasing the valve member is from about 20 mm to about 40 mm.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A blowoff valve for a turbocharger of an internal
combustion engine, comprising:
a valve body defining an air inlet and an air outlet with an internal passage extending therebetween;
a valve member arranged in the internal passage and movable into an airflow restricting position in which airflow between the air inlet and the air outlet is restricted thereby; and
a non-coiled spring biasing the valve member into the airflow restricting position; and wherein
air pressure at the air inlet above a blowoff threshold will move the valve member out of the restricting position permitting airflow between the air inlet and the air outlet.

2. The blowoff valve of claim 1, wherein the non-coiled spring comprises a wave spring.

3. The blowoff valve of claim 2, wherein the non-compressed length of the non-coiled wave spring is about 10 mm to about 100 mm.

4. The blowoff valve of claim 3, wherein the non-compressed length of the non-coiled wave spring is about 20 mm to about 40 mm.

5. The blowoff valve of claim 1, further comprising a pressure control connector extending from the valve body for regulating vacuum pressure within the valve body.

6. The blowoff valve of claim 1, wherein the valve member is configured to at least partially surround the non-coiled spring therein.

7. The blowoff valve of claim 1, wherein the valve member includes a spring seat having a first surface for the non-coiled spring to contact and bias the valve member.

8. The blowoff valve of claim 7, wherein the valve body further defines a valve cover positioned relative to the spring seat for providing a second surface for the non-coiled spring to contact and bias the valve member.

9. The blowoff valve of claim 8, wherein the distance between the first surface and the second surface is in a range of about 10 mm to about 50 mm.

10. The blowoff valve of claim 9, wherein the distance between the first surface and the second surface is in a range of about 12 mm to about 20 mm.

11. The blowoff valve of claim 1, wherein the valve body includes an internal wall defining a spring chamber separate from the internal passage, the non-coiled spring being arranged therein.

12. The blowoff valve of claim 11, wherein the spring chamber has a length of about 10 mm to about 50 mm.

13. The blowoff valve of claim 12, wherein the spring chamber has a length of about 12 mm to about 20 mm.

14. The blowoff valve of claim 11, wherein the internal wall defines a stem passage therethrough, and the valve member includes a valve stem having a spring seat, the spring seat being located in the spring chamber and the valve stem passing through the stem passage into the internal passage.

15. The blowoff valve of claim 11, wherein the internal wall further defines at least one port hole for providing equalization of pressure in the internal passage and the spring chamber.

16. A turbocharger system for an internal combustion engine,
the system comprising:
the blowoff valve of claim 1; and
a turbocharger compressor, the compressor comprising an air input for receiving air into the compressor and an air output for expelling compressed air from the compressor;
wherein the air inlet of the blowoff valve is in communication with the air output of the compressor such that air pressure at the air inlet above a blowoff threshold will move the valve member out of the restricting position permitting airflow between the air inlet and the air outlet.

17. The system of claim 16, wherein the blowoff valve further comprises a pressure control connector interconnected with the manifold of the engine for regulating vacuum pressure between the manifold and the valve body.

18. A blowoff valve comprising:
a valve body defining an air inlet, an access port, and an air outlet with an internal passage extending therebetween;
a valve cover removably attached to the valve body in covering alignment with the access port;
a valve member arranged in the internal passage and movable into an airflow restricting position in which airflow between the air inlet and the air outlet is restricted thereby; and
a non-coiled spring biasing the valve member into the airflow restricting position;
wherein air pressure at the air inlet above a blowoff threshold will move the valve member out of the restricting position permitting airflow between the air inlet and the air outlet.

19. A method of assembling a compact blowoff valve, comprising:
providing a valve body defining an air inlet, an access port, and an air outlet with an internal passage extending therebetween;
arranging a valve member comprising a spring seat in the internal passage such that it is movable into an airflow restricting position in which airflow between the air inlet and the air outlet is restricted thereby;
positioning a non-coiled spring within the internal passage such that a first end of the non-coiled spring abuts the spring seat and is capable of biasing the valve member into the airflow restricting position; and
attaching a valve cover to the valve body in covering alignment with the access port and opposite the spring seat such that it contacts a second end of the non-coiled spring; wherein air pressure at the air inlet above a blowoff threshold will move the valve member out of the restricting position permitting airflow between the air inlet and the air outlet during operation of the assembled blowoff valve.

20. The method of claim 19, wherein the length of the internal passage of the valve body is from about 12 mm to about 20 mm measured from the spring seat of the valve member to the valve cover when the non-coiled spring is biasing the valve member into the airflow restricting position, and wherein the uncompressed length of the non-coiled spring biasing the valve member is from about 20 mm to about 40 mm.
